(19) United States
(12) Patent Application Publication
(10) Pub. No.: US 2016/0321368 A1
(43) Pub. Date: Nov. 3, 2016

(54) Speech Searching Method And Speech Searching Device

(71) Applicant: BAIDU ONLINE NETWORK TECHNOLOGY (BEIJING) CO., LTD., Beijing (CN)

(72) Inventors: Zhen WANG, Beijing (CN); Na ZHANG, Beijing (CN); Kai CHEN, Beijing (CN); Wenbo YANG, Beijing (CN); Xi WANG, Beijing (CN)

(21) Appl. No.: 14/962,653

(22) Filed: Dec. 8, 2015

(30) Foreign Application Priority Data
Apr. 28, 2015 (CN) 201510208081.9

(51) Int. Cl. G06F 17/30; G10L 15/18; G06Q 30/06; G10L 15/22

(52) U.S. Cl. CPC G06F 17/30867; G10L 15/22; G10L 15/1815; G06F 17/30241; G06F 17/30554; G06Q 30/0625; G06F 17/3087; G10L 2015/223

(57) ABSTRACT

A speech searching method and a speech searching device are provided. The method includes: receiving a speech; converting the speech into a text and performing a semantic recognition on the text to obtain a result of the semantic recognition; determining a searching demand by combining the result of the semantic recognition with a current geographic position and/or a search context; performing a search according to the searching demand, obtaining services satisfying the searching demand and providing the services.

### CROSS REFERENCE TO RELATED APPLICATION

This application claims priority to and benefits of Chinese Patent Application No. 201510208081.9, filed with the State Intellectual Property Office of P. R. China on Apr. 28, 2015, the entire content of which are incorporated herein by reference.

### FIELD

Embodiments of the present disclosure generally relate to the field of Internet technologies, and more particularly, to a speech searching method and a speech searching device.

### BACKGROUND

A speech is an expression way, which is earlier and more natural than a text. In the Internet age, it is still very inconvenient to express demands relying on the speech. However, the present mobile Internet has changed ways of expressing demands for people, a speech, a picture and even a contact device may all be used to express demands. The speech is a very important one in these diversified expression ways.

However, in the related art, when the user uses the speech for searching, the searching results returned by the search engine cannot satisfy the user's actual demand in most cases, so the user experience is poorer and it is not conducive to the promotion of the speech searching.

### SUMMARY

Embodiments of the present disclosure seek to solve at least one of the problems existing in the related art to at least some extent.

Embodiments of a first aspect of the present disclosure provide a speech searching method, including: receiving a speech; converting the speech into a text and performing a semantic recognition on the text to obtain a result of the semantic recognition; determining a searching demand by combining the result of the semantic recognition with a current geographic position and/or a search context; performing a search according to the searching demand, obtaining services satisfying the searching demand and providing the services.

With the speech searching method according to embodiments of the present disclosure, by converting the speech from the user into the text, performing the semantic recognition on the text, then determining a searching demand of the user by combining the result of the semantic recognition with the current geographic position and/or the search context of the user, and then performing the search according to the searching demand, obtaining the services satisfying the searching demand and providing the services to the user, which may determine the searching demand of the user accurately by performing an intention recognition on the speech from the user and provide the services satisfying the searching demand to the user, thus improving a satisfaction degree of the user and an experience degree of the user, and facilitating the promotion of the speech searching.

Embodiments of a second aspect of the present disclosure provide a speech searching device, including: a receiving module, configured to receive a speech; a converting module, configured to convert the speech into a text; a recognizing module, configured to perform a semantic recognition on the text to obtain a result of the semantic recognition; a determining module, configured to determine a searching demand by combining the result of the semantic recognition with a current geographic position and/or a search context; a searching module, configured to perform a search according to the searching demand, to obtain services satisfying the searching demand and to provide the services.

With the speech searching device according to embodiments of the present disclosure, the converting module converts the speech from the user into the text, the recognizing module performs the semantic recognition on the text, then the determining module determines the searching demand of the user by combining the result of the semantic recognition with the current geographic position and/or the search context of the user, and then the searching module performs the search according to the searching demand, obtains the services satisfying the searching demand and provides the services to the user, which may determine the searching demand of the user accurately by performing an intention recognition on the speech from the user and provide the services satisfying the searching demand to the user, thus improving a satisfaction degree of the user and an experience degree of the user, and facilitating the promotion of the speech searching.

Embodiments of a third aspect of the present disclosure provide a non-transitory computer readable storage medium, including a computer program stored thereon, which when executed by an instruction execution system, causes the system to implement the speech searching method according to embodiments of the first aspect of the present disclosure.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a speech searching method according to an embodiment of the present disclosure;

FIG. 2 is a schematic diagram illustrating converting a speech into a text according to an embodiment of the present disclosure;

FIG. 3 is a schematic diagram illustrating obtaining services satisfying a searching demand according to the searching demand of a user according to an embodiment of the present disclosure;

FIG. 4 is a schematic diagram illustrating performing a subsequent operation of a service selected by a user according to an embodiment of the present disclosure;

FIG. 5 is a schematic diagram illustrating obtaining services satisfying a searching demand according to the searching demand of a user according to another embodiment of the present disclosure;

FIG. 6 is a schematic diagram illustrating obtaining services satisfying a searching demand according to the searching demand of a user according to still another embodiment of the present disclosure;

FIG. 7 is a schematic diagram illustrating obtaining services satisfying a searching demand according to the searching demand of a user according to yet another embodiment of the present disclosure;

FIG. 8 is a schematic diagram illustrating performing a subsequent operation of a service selected by a user according to another embodiment of the present disclosure;

FIG. 9 is a schematic diagram illustrating performing a subsequent operation of a service selected by a user according to yet another embodiment of the present disclosure;

FIG. 10 is a schematic diagram illustrating performing a subsequent operation of a service selected by a user according to still another embodiment of the present disclosure;

FIG. 11 is a block diagram of a speech searching device according to an embodiment of the present disclosure;

FIG. 12 is a block diagram of a speech searching device according to another embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure. In contrast, the present disclosure may include alternatives, modifications and equivalents within the spirit and scope of the appended claims.

FIG. 1 is a flow chart of a speech searching method according to an embodiment of the present disclosure. As shown in FIG. 1, the speech searching method includes following steps.

In step 101, a speech from a user is received.

In step 102, the speech is converted into a text and a semantic recognition is performed on the text to obtain a result of the semantic recognition.

In step 103, a searching demand of the user is determined by combining the result of the semantic recognition with a current geographic position and/or a search context of the user.

In step 104, a search is performed according to the searching demand, services satisfying the searching demand are obtained and the services are provided to the user.

Further, after the services are provided to the user, the search engine also may obtain a service selected by the user from the provided services, and perform a subsequent operation of the selected service.

In an implementation of the embodiment, the searching demand of the user is a catering demand; step 104 may be steps of: performing the search according to the catering demand, obtaining restaurants having a distance from the current geographic position of the user less than a preset distance, and displaying information of the restaurants to the user; obtaining a service selected by the user from the provided services, and performing a subsequent operation of the selected service may be steps of: obtaining a restaurant selected by the user, displaying particulars of the selected restaurant to the user, and performing one or a combination of following operations according to a choice of the user: online booking, queuing, ordering, paying and buying a coupon. The preset distance may be set independently when specifically implementing. The preset distance will not be limited in the embodiment, for example, the preset distance may be 1000 m.

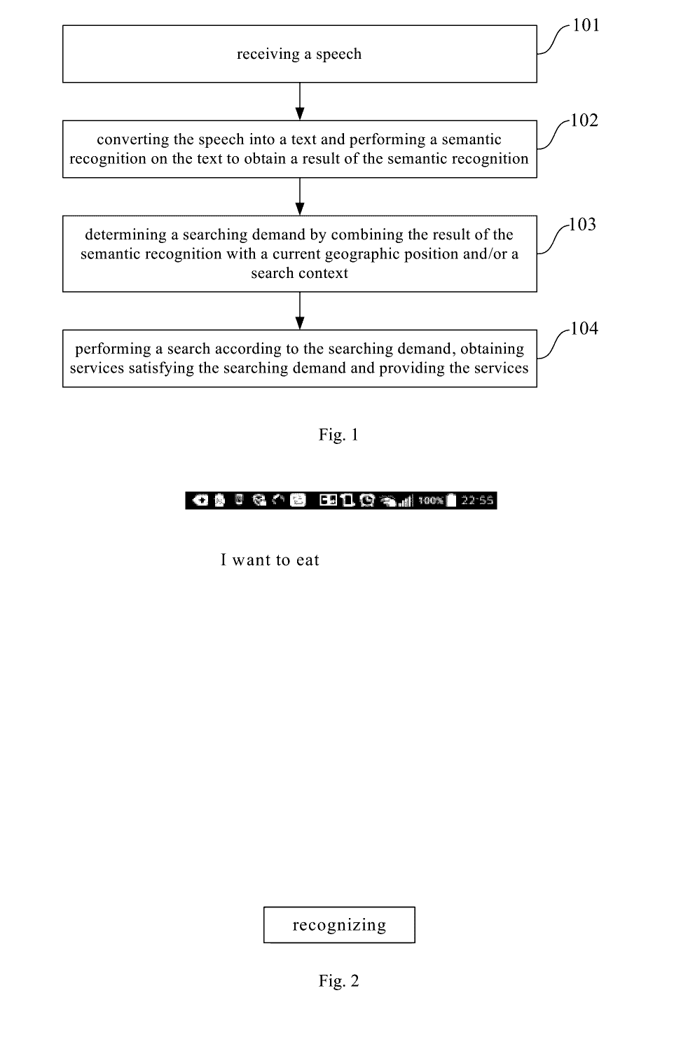

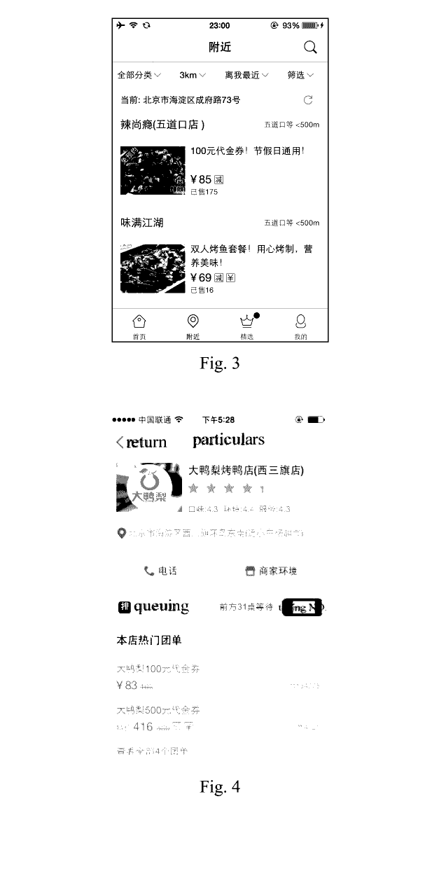

For example, when the user says “I want to eat” into the microphone if he/her wants to use the speech for searching, the search engine receives the speech of “I want to eat” from the user. FIG. 2 is a schematic diagram illustrating converting a speech into a text according to an embodiment of the present disclosure. As shown in FIG. 2, the search engine may convert the speech into the text and then perform the semantic recognition on the text. FIG. 3 is a schematic diagram illustrating obtaining services satisfying a searching demand according to the searching demand of a user according to an embodiment of the present disclosure. As shown in FIG. 3, it is determined that the searching demand of the user is the catering demand according to the result of the semantic recognition, that is, the user wants to find a place for eating, so the search engine may perform the search according to the catering demand, obtain the restaurants having the distance from the current geographic position of the user less than the preset distance and display the restaurants to the user for selecting. After the user selects one restaurant from the displayed restaurants, the search engine may obtain the selected restaurant. FIG. 4 is a schematic diagram illustrating performing a subsequent operation of a service selected by a user according to an embodiment of the present disclosure. As shown in FIG. 4, the search engine may display the particulars of the restaurant selected by the user, so the user may view the information of the restaurant selected by the user, in addition, the search engine may also perform one or the combination of following operations according to a choice of the user: online booking, queuing, ordering, paying, buying a coupon, etc.

In another implementation of the embodiment, the searching demand of the user is a car rental demand; step 104 may be steps of: performing the search according to the car rental demand, displaying a page of car rental services to the user, in which information of car rental services obtained by performing the search, having a distance from the current geographic position of the user less than a preset distance and satisfying the car rental demand is displayed on the page. Similarly, the preset distance may be set independently when specifically implementing. The preset distance will not be limited in the embodiment, for example, the preset distance may be 1000 m.

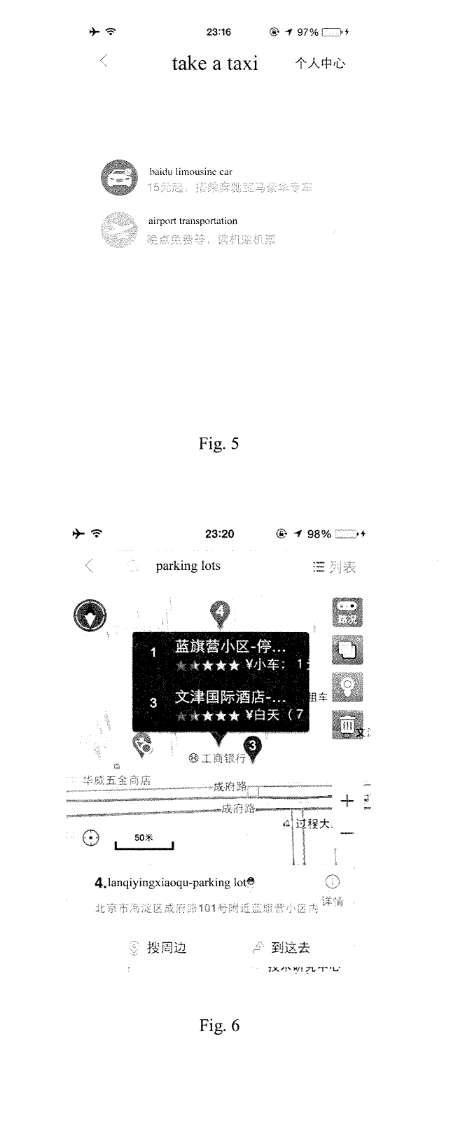

For example, when the user says “I want to take a taxi” into the microphone if he/her wants to use the speech for searching, the search engine receives the speech of “I want to taxi” from the user. The search engine converts the speech into the text and then performs the semantic recognition on the text. It is determined that the searching demand of the user is the car rental demand according to the result of the semantic recognition, that is, the user wants to take a taxi or the limousine service. Thus, the search engine may perform the search according to the car rental demand, and obtain the information of car rental services, and then display the information of car rental services on the page of car rental services for the user to view, as shown in FIG. 5, in which FIG. 5 is a schematic diagram illustrating obtaining services satisfying a searching demand according to the searching demand of a user according to another embodiment of the present disclosure. Then, the user may select the car rental service according to his/her own needs.

In yet another implementation of the embodiment, the searching demand of the user is a position seeking demand; step 104 may be steps of: performing the search according to the position seeking demand, obtaining geographic positions having a distance from the current geographic position of the user less than a preset distance, and providing the geographic positions obtained by performing the search to the user. The preset distance may be set independently when specifically implementing. The preset distance will not be limited in the embodiment, for example, the preset distance may be 1000 m. In this case, obtaining a service selected by the user from the provided services, and performing a subsequent operation of the selected service includes steps of: obtaining a geographic position selected by the user, generating a navigation path with the selected geographic position as a target position, and performing a navigation for the user according to the navigation path.

For example, when the user says “I want to park” or “I want to go to the washroom” into the microphone if the user wants to use the speech for searching, the search engine receives the speech of “I want to park” or “I want to go to the washroom” from the user. The search engine converts the speech into the text and then performs the semantic recognition on the text. It is determined that the searching demand of the user is the position seeking demand according to the result of the semantic recognition, that is, the user wants to find a nearby parking lot or washroom. Thus, the search engine may perform the search according to the position seeking demand, and obtain positions of parking lots or lavatories having a distance from the current geographic position of the user less than the preset distance, and display the positions of parking lots or lavatories to the user. After the user selects one from the positions, the search engine obtains the position of parking lot or washroom selected by the user, and then generates the navigation path with the selected position as the target position, and performs the navigation for the user according to the navigation path, as shown in FIG. 6, in which FIG. 6 is a schematic diagram illustrating obtaining services satisfying a searching demand according to the searching demand of a user according to still another embodiment of the present disclosure.

In yet another implementation of the embodiment, the searching demand of the user is a financial management demand; step 104 may be steps of: performing the search according to the financial management demand, obtaining information of financial management products, displaying a page of financial management products to the user, in which the information of financial management products is displayed on the page; obtaining a service selected by the user from the provided services, and performing a subsequent operation of the selected service may include steps of: obtaining a financial management product selected by the user, and performing an online purchase operation.

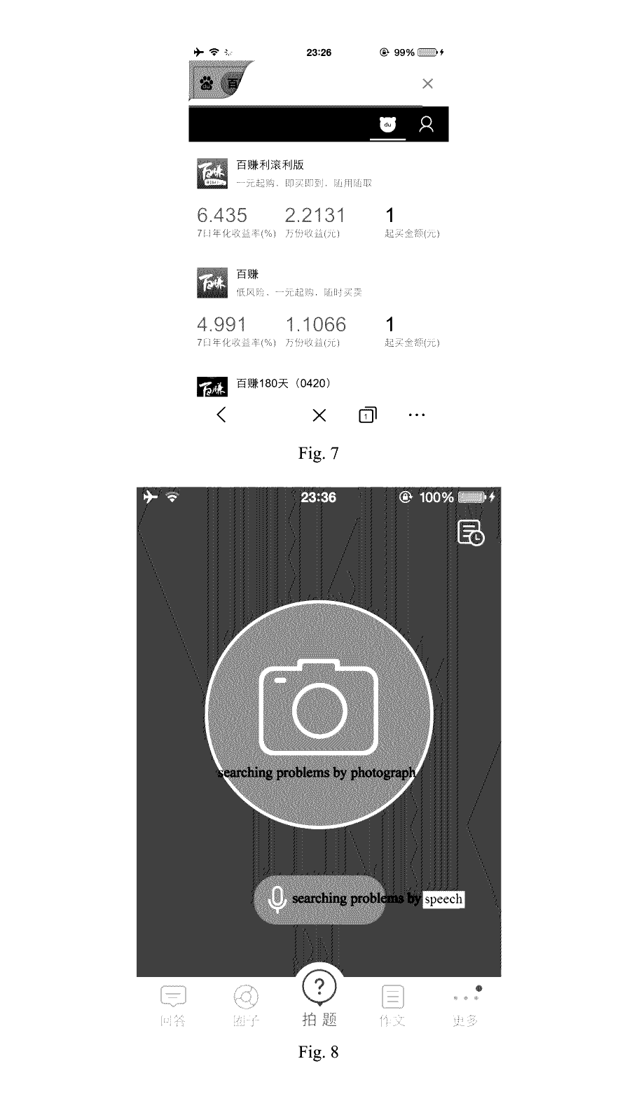

For example, when the user says “I want to buy funds” or “I want to buy shares” into the microphone if the user wants to use the speech for searching, the search engine receives the speech of “I want to buy funds” or “I want to buy shares” from the user. The search engine converts the speech into the text and then performs the semantic recognition on the text. It is determined that the searching demand of the user is the financial management demand according to the result of the semantic recognition, that is, the user wants to find the information of the financial management products. The search engine may perform the search according to the financial management demand, obtain the information of the financial management products and display the page of financial management products to the user, in which the information of the financial management products is displayed on the page, as shown in FIG. 7, in which FIG. 7 is a schematic diagram illustrating obtaining services satisfying a searching demand according to the searching demand of a user according to yet another embodiment of the present disclosure. Then, the user may select corresponding financial management product from the page of financial management products, and the search engine obtains the selected financial management product and then performs the online purchase operation.

In yet another implementation of the embodiment, the searching demand of the user is a problem solving demand; step 104 may be steps of: performing the search according to the problem solving demand, obtaining information of problem solving services, displaying a page of problem solving services to the user, in which the information of the problem solving services is displayed on the page; obtaining a service selected by the user from the provided services, and performing a subsequent operation of the selected service includes steps of: obtaining a problem solving service selected by the user, and displaying a page of the problem solving service selected by the user; receiving a problem to be solved that is uploaded by the user via a picture or a speech; returning the problem uploaded by the user and an answer corresponding to the problem to the user.

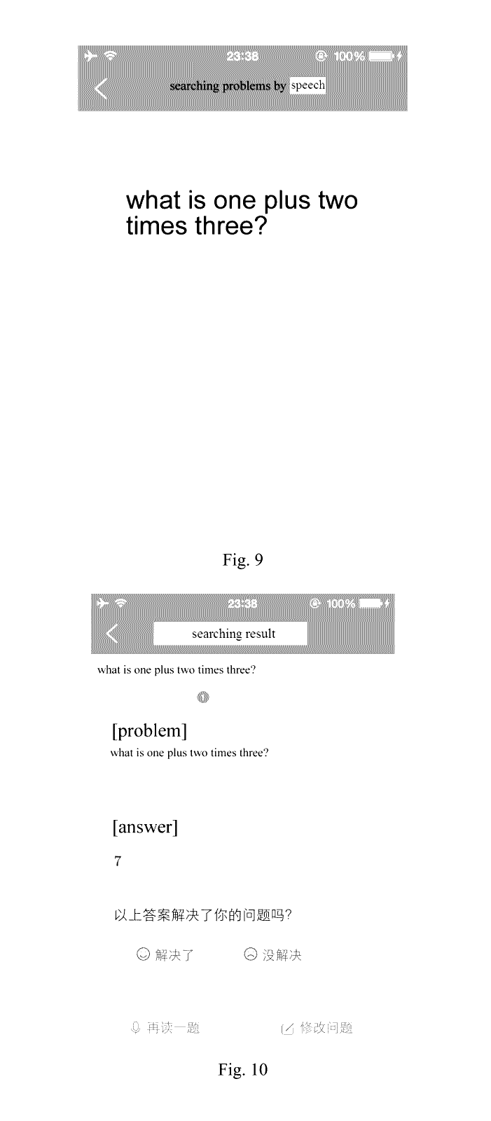

For example, when the user says “I want to solve problems” into the microphone if the user wants to use the speech for searching, the search engine receives the speech of “I want to solve problems” from the user. The search engine converts the speech into the text and then performs the semantic recognition on the text. It is determined that the searching demand of the user is the problem solving demand according to the result of the semantic recognition, that is, the user wants to find the answer to the problem to be solved. The search engine may perform the search according to the problem solving demand, obtain the information of the problem solving services, and provide the page of problem solving services to the user, in which the information of the problem solving services is displayed on the page. The user may select one problem solving service on the page of problem solving services, and the search engine obtains the problem solving service selected by the user and then displays the page of the problem solving service selected by the user to the user, for example, a homework helping page, as shown in FIG. 8, in which FIG. 8 is a schematic diagram illustrating performing a subsequent operation of a service selected by a user according to another embodiment of the present disclosure. Then, the search engine may receive the problem to be solved that is uploaded by the user via the picture or the speech, for example, as shown in FIG. 9, the search engine may receive the problem of “what is one plus two times three” uploaded by the user via the speech, in which FIG. 9 is a schematic diagram illustrating performing a subsequent operation of a service selected by a user according to yet another embodiment of the present disclosure. Finally, the search engine returns the problem uploaded by the user and the answer corresponding to the problem to the user, as shown in FIG. 10, in which FIG. 10 is a schematic diagram illustrating performing a subsequent operation of a service selected by a user according to still another embodiment of the present disclosure.

In the above described speech searching methods, firstly the speech from the user may be converted into the text, and the semantic recognition is performed on the text, then the searching demand of the user is determined by combining the result of the semantic recognition with the current geographic position and/or the search context of the user, and then the search is performed according to the searching demand, the services satisfying the searching demand are obtained and the services are provided to the user, which determines the searching demand of the user accurately by performing an intention recognition on the speech from the user and provides the services satisfying the searching demand to the user, thus improving a satisfaction degree of the user and an experience degree of the user, and facilitating the promotion of the speech searching.

FIG. 11 is a block diagram of a speech searching device according to an embodiment of the present disclosure. The speech searching device shown in FIG. 11 may be used as the search engine or a portion of the search engine to realize the flow shown in FIG. 1. As shown in FIG. 11, the speech searching device includes a receiving module 1101, a converting module 1102, a recognizing module 1103, a determining module 1104 and a searching module 1105.

The receiving module 1101 is configured to receive a speech from a user.

The converting module 1102 is configured to convert the speech into a text.

The recognizing module 1103 is configured to perform a semantic recognition on the text to obtain a result of the semantic recognition.

The determining module 1104 is configured to determine a searching demand of the user by combining the result of the semantic recognition with a current geographic position and/or a search context of the user.

The searching module 1105 is configured to perform a search according to the searching demand, to obtain services satisfying the searching demand and to provide the services to the user.

In the above described speech searching device, the converting module 1102 converts the speech from the user into the text, the recognizing module 1103 performs the semantic recognition on the text, then the determining module 1104 determines the searching demand of the user by combining the result of the semantic recognition with the current geographic position and/or the search context of the user, and the searching module 1105 performs the search according to the searching demand, obtains the services satisfying the searching demand and provides the services to the user, thus improving a satisfaction degree of the user and an experience degree of the user, and facilitating the promotion of the speech searching.

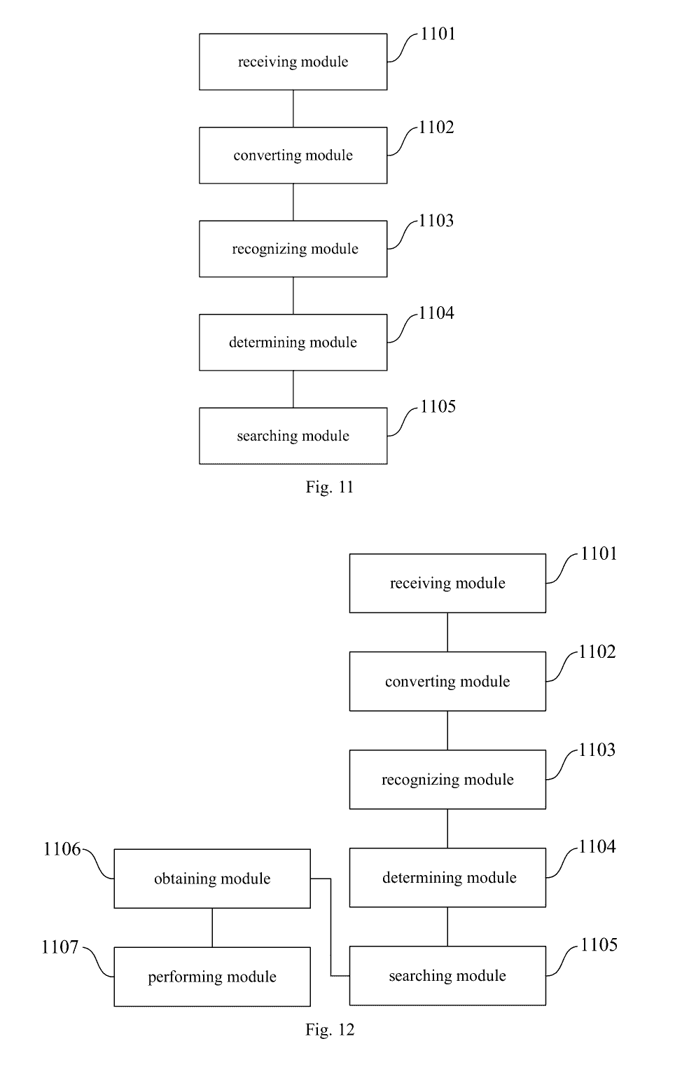

FIG. 12 is a block diagram of a speech searching device according to another embodiment of the present disclosure. The difference between the speech searching device shown in FIG. 12 and the speech searching device shown in FIG. 11 lies in that the speech searching device shown in FIG. 12 may further include an obtaining module 1106 and a performing module 1107.

The obtaining module 1106 is configured to obtain a service selected by the user from the provided services.

The performing module 1107 is configured to perform a subsequent operation of the selected service.

In an implementation of the embodiment, the determining module 1104 determines that the searching demand of the user is a catering demand. The searching module 1105 is further configured to perform the search according to the catering demand, to obtain restaurants having a distance from the current geographic position of the user less than a preset distance, and to display information of the restaurants to the user; then the obtaining module 1106 is further configured to obtain a restaurant selected by the user; the performing module 1107 is further configured to display particulars of the selected restaurant to the user, and perform one or a combination of following operations according to a choice of the user: online booking, queuing, ordering, paying and buying a coupon. The preset distance may be set independently when specifically implementing. The preset distance will not be limited in the embodiment, for example, the preset distance may be 1000 m.

In another implementation of the embodiment, the determining module 1104 determines that the searching demand of the user is a car rental demand. The searching module 1105 is further configured to perform the search according to the car rental demand, and to display a page of car rental services to the user, in which information of car rental services obtained by performing the search, having a distance from the current geographic position of the user less than a preset distance and satisfying the car rental demand is displayed on the page. Similarly, the preset distance may be set independently when specifically implementing. The preset distance will not be limited in the embodiment, for example, the preset distance may be 1000 m.

In yet another implementation of the embodiment, the determining module 1104 determines that the searching demand of the user is a position seeking demand; the searching module 1105 is further configured to perform the search according to the position seeking demand, to obtain geographic positions having a distance from the current geographic position of the user less than a preset distance, and to provide the geographic positions obtained by performing the search to the user; the obtaining module 1106 is further configured to obtain a geographic position selected by the user; the performing module 1107 is further configured to generate a navigation path with the selected geographic position as a target position, and to perform a navigation for the user according to the navigation path.

In yet another implementation of the embodiment, the determining module 1104 determines that the searching demand of the user is a financial management demand; the searching module 1105 is further configured to perform the search according to the financial management demand, to obtain information of financial management products, and to display a page of financial management products to the user, in which the information of financial management products is displayed on the page; the obtaining module 1106 is further configured to obtain a financial management product selected by the user; the performing module 1107 is further configured to perform an online purchase operation.

In yet another implementation of the embodiment, the determining module 1104 determines that the searching demand of the user is a problem solving demand; the searching module 1105 is further configured to perform the search according to the problem solving demand, to obtain information of problem solving services, and to display a page of problem solving services to the user, in which the information of the problem solving services is displayed on the page; the obtaining module 1106 is further configured to obtain a problem solving service selected by the user; the performing module 1107 is further configured to display a page of the problem solving service selected by the user, to receive a problem to be solved that is uploaded by the user via a picture or a speech, and to return the problem uploaded by the user and an answer corresponding to the problem to the user.

The above described speech searching devices may determine the searching demand of the user accurately by performing an intention recognition on the speech from the user, and provides the services satisfying the searching demand to the user, thus improving the satisfaction degree of the user and the experience degree of the user, and facilitating the promotion of the speech searching.

In some embodiments, the speech searching device may further include a non-transitory computer-readable medium comprising computer-executable instructions stored thereon; and an instruction execution system, which is configured by the instructions to implement at least one of the receiving module, the converting module, the recognizing module, the determining module and the searching module.

According to an embodiment of the present disclosure, a non-transitory computer readable storage medium is provided. The non-transitory computer readable storage medium includes a computer program stored thereon, which when executed by an instruction execution system, causes the system to implement a speech searching method, the method comprising acts of: receiving a speech; converting the speech into a text and performing a semantic recognition on the text to obtain a result of the semantic recognition; determining a searching demand by combining the result of the semantic recognition with a current geographic position and/or a search context; performing a search according to the searching demand, obtaining services satisfying the searching demand and providing the services.

In some embodiments, the method further comprises an act of: obtaining a service selected from the provided services, and performing a subsequent operation of the selected service after providing the services.

It is to be understood that, in the description of the present disclosure, terms of “first” and “second” are only used for description and cannot be seen as indicating or implying relative importance. Furthermore, unless otherwise explained, it is to be understood that a term of “a plurality of” refers to two or more.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The above-mentioned storage medium may be a read-only memory, a magnetic disc, an optical disc, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A speech searching method, comprising:
receiving a speech;
converting the speech into a text and performing a semantic recognition on the text to obtain a result of the semantic recognition;
determining a searching demand by combining the result of the semantic recognition with a current geographic position and/or a search context;
performing a search according to the searching demand, obtaining services satisfying the searching demand and providing the services.

2. The method according to claim 1, after providing the services, further comprising:
obtaining a service selected from the provided services, and performing a subsequent operation of the selected service.

3. The method according to claim 2, wherein the searching demand is a catering demand,
performing a search according to the searching demand, obtaining services satisfying the searching demand and providing the services comprises:
performing the search according to the catering demand, obtaining restaurants having a distance from the current geographic position less than a preset distance, and displaying information of the restaurants;
obtaining a service selected from the provided services, and performing a subsequent operation of the selected service comprises:
obtaining a restaurant selected, displaying particulars of the selected restaurant, and performing one or a combination of following operations according to a choice: online booking, queuing, ordering, paying and buying a coupon.

4. The method according to claim 2, wherein the searching demand is a car rental demand,
performing a search according to the searching demand, obtaining services satisfying the searching demand and providing the services comprises:
performing the search according to the car rental demand, displaying a page of car rental services, wherein information of car rental services obtained by performing the search, having a distance from the current geographic position less than a preset distance and satisfying the car rental demand is displayed on the page.

5. The method according to claim 2, wherein the searching demand is a position seeking demand,
performing a search according to the searching demand, obtaining services satisfying the searching demand and providing the services comprises:
performing the search according to the position seeking demand, obtaining geographic positions having a distance from the current geographic position less than a preset distance, and providing the geographic positions obtained by performing the search;
obtaining a service selected from the provided services, and performing a subsequent operation of the selected service comprises:
obtaining a geographic position selected, generating a navigation path with the selected geographic position as a target position, and performing a navigation according to the navigation path.

6. The method according to claim 2, wherein the searching demand is a financial management demand,
performing a search according to the searching demand, obtaining services satisfying the searching demand and providing the services comprises:
performing the search according to the financial management demand, obtaining information of financial management products, displaying a page of financial management products, wherein the information of financial management products is displayed on the page;
obtaining a service selected from the provided services, and performing a subsequent operation of the selected service comprises:
obtaining a financial management product selected, and performing an online purchase operation.

7. The method according to claim 2, wherein the searching demand is a problem solving demand,
performing a search according to the searching demand, obtaining services satisfying the searching demand and providing the services comprises:
performing the search according to the problem solving demand, obtaining information of problem solving services, displaying a page of problem solving services, wherein the information of the problem solving services is displayed on the page;
obtaining a service selected from the provided services, and performing a subsequent operation of the selected service comprises:
obtaining a problem solving service selected, and displaying a page of the problem solving service selected;
receiving a problem to be solved that is uploaded via a picture or a speech;
returning the problem uploaded and an answer corresponding to the problem.

8. A speech searching device, comprising:
a receiving module, configured to receive a speech;
a converting module, configured to convert the speech into a text;
a recognizing module, configured to perform a semantic recognition on the text to obtain a result of the semantic recognition;
a determining module, configured to determine a searching demand by combining the result of the semantic recognition with a current geographic position and/or a search context;
a searching module, configured to perform a search according to the searching demand, to obtain services satisfying the searching demand and to provide the services.

9. The device according to claim 8, further comprising:
an obtaining module configured to obtain a service selected from the provided services;
a performing module configured to perform a subsequent operation of the selected service.

10. The device according to claim 9, wherein the searching demand is a catering demand,
the searching module is further configured to perform the search according to the catering demand, to obtain restaurants having a distance from the current geographic position less than a preset distance, and to display information of the restaurants;
the obtaining module is further configured to obtain a restaurant selected;
the performing module is further configured to display particulars of the selected restaurant, and perform one or a combination of following operations according to a choice:
online booking, queuing, ordering, paying and buying a coupon.

11. The device according to claim 9, wherein the searching demand is a car rental demand,
the searching module is further configured to perform the search according to the car rental demand, and to display a page of car rental services, wherein information of car rental services obtained by performing the search, having a distance from the current geographic position less than a preset distance and satisfying the car rental demand is displayed on the page.

12. The device according to claim 9, wherein the searching demand is a position seeking demand,
the searching module is further configured to perform the search according to the position seeking demand, to obtain geographic positions having a distance from the current geographic position less than a preset distance, and to provide the geographic positions obtained by performing the search;
the obtaining module is further configured to obtain a geographic position selected;
the performing module is further configured to generate a navigation path with the selected geographic position as a target position, and to perform a navigation according to the navigation path.

13. The device according to claim 9, wherein the searching demand is a financial management demand,
the searching module is further configured to perform the search according to the financial management demand, to obtain information of financial management products, and to display a page of financial management products, wherein the information of financial management products is displayed on the page;
the obtaining module is further configured to obtain a financial management product selected;
the performing module is further configured to perform an online purchase operation.

14. The device according to claim 9, wherein the searching demand is a problem solving demand,
the searching module is further configured to perform the search according to the problem solving demand, to obtain information of problem solving services, and to display a page of problem solving services, wherein the information of the problem solving services is displayed on the page;
the obtaining module is further configured to obtain a problem solving service selected;
the performing module is further configured to display a page of the problem solving service selected, to receive a problem to be solved that is uploaded via a picture or a speech, and to return the problem uploaded and an answer corresponding to the problem.

15. The device according to claim 8, further comprising:
a non-transitory computer-readable medium comprising computer-executable instructions stored thereon; and
an instruction execution system, which is configured by the instructions to implement at least one of the receiving module, the converting module, the recognizing module, the determining module and the searching module.

16. A non-transitory computer readable storage medium, comprising a computer program stored thereon, which when executed by an instruction execution system, causes the system to implement a speech searching method, the method comprising acts of:
receiving a speech;
converting the speech into a text and performing a semantic recognition on the text to obtain a result of the semantic recognition;
determining a searching demand by combining the result of the semantic recognition with a current geographic position and/or a search context;
performing a search according to the searching demand, obtaining services satisfying the searching demand and providing the services.

17. The non-transitory computer readable storage medium according to claim 16, wherein the method further comprises an act of:
obtaining a service selected from the provided services, and performing a subsequent operation of the selected service after providing the services.
